(19) United States
(12) Patent Application Publication
(10) Pub. No.: US 2012/0029873 A1
(43) Pub. Date: Feb. 2, 2012

(54) MACHINE-IMPLEMENTED METHOD AND AN ELECTRONIC DEVICE FOR GRAPHICALLY ILLUSTRATING A STATISTICAL DISPLAY BASED ON A SET OF NUMERICAL DATA, AND A COMPUTER PROGRAM PRODUCT

(76) Inventors: Chang-Shan Chuang, Taipei City (TW); Hao-Yuan Chuang, Taipei City (TW)

(21) Appl. No.: 12/968,158

(22) Filed: Dec. 14, 2010

(30) Foreign Application Priority Data
Jul. 30, 2010 (TW) 099125344

(51) Int. Cl. G06F 17/18

(52) U.S. Cl. 702/181

(57) ABSTRACT

A machine-implemented method for graphically illustrating a statistical display based on a set of numerical data includes the steps of: (a) finding a median and a subset of the numerical data, each corresponding to a member of a predetermined set of cumulative distribution probabilities of the Gaussian distribution; (b) computing a mean and a standard deviation; (c) computing a plurality of reference values, each differing from the mean by a corresponding predetermined number multiplied by the standard deviation; (d) generating a plot that includes a first line, a second line and a plurality of connecting lines, the first line having the median and the subset marked thereon, the second line having the mean and the reference values marked thereon, the connecting lines respectively connecting the median and the mean, and corresponding pairs of the subset of the numerical data and the reference values; and (e) outputting the plot for viewing by a user.

### CROSS-REFERENCE TO RELATED APPLICATION

This application claims priority of Taiwanese Application No. 099125344, filed on Jul. 30, 2010.

### BACKGROUND OF THE INVENTION

1. Field of the Invention

The invention relates to a machine-implemented method and an electronic device for graphically illustrating a statistical display and a computer program product for implementing the method, more particularly to a machine-implemented method and an electronic device for graphically illustrating a statistical display based on a set of numerical data, the display being easy to read and requiring little display resources, and a computer program product for implementing the method.

2. Description of the Related Art

Statistical analysis tools are used to collect and organize data, and to present an objective interpretation of the collection of data through a statistical plot. Currently known types of statistical plots include dot plot, histogram, probability plot, residual plot, box plot, block plot, etc. An appropriate statistical plot can capture important information about the collection of data. Thus, statistics is widely used in the fields of medicine, finance and social studies and by governments.

When reading a statistical plot, an observation emphasis is the central tendency and statistical dispersion of the distribution of the data. Central tendency is generally measured by mean, median, geometric mean and mode values. Statistical dispersion indicates variability in a set of data (i.e., the degree to which values are scattered around a central point, e.g., mean or median), and is measured by range, variance, standard deviation, etc. An observation that is numerically distant from the mean by more than twice the standard deviation is generally referred to as an unusual observation, and an observation that is numerically distant from the mean by more than three times the standard deviation is generally referred to as an outlier if the distribution of the data is Gaussian distribution. Outliers represent the most extreme observations, which rarely occur, but may not be naively ignored.

Shown in FIG. 1 is a probability density function for the “Gaussian distribution” (also known as the “normal distribution”) with the mean denoted by (μ) and the standard deviation denoted by (σ). When a probability distribution is close to the Gaussian distribution, approximately 68.26% (34.13%×2) of the values of the distribution would fall within the range of one standard deviation (σ) away from the mean (μ), approximately 95.44% (68.26%+13.59%×2) of the values of the distribution fall within the range of twice the standard deviation (σ) away from the mean (μ), and approximately 99.72% (95.44%+2.14%×2) of the values of the distribution fall within the range of three times the standard deviation (σ) away from the mean (μ).

Shown in FIG. 2 is a box plot (also known as box-and-whisker plot), which depicts a collection of data through what is known as the “five-number summary”, which includes five important sample percentiles: the smallest observation (sample minimum), lower quartile (Q1) (i.e., the 25^{th} percentile), medium (Q2) (i.e., the 50^{th} percentile), upper quartile (Q3) (i.e., the 75th percentile), and largest observation (sample maximum). The two sides of the box of a box plot respectively represent the lower and upper quartiles (Q1, Q3), the band at the middle of the box represents the median (Q2), and the ends of the whiskers normally represent the sample minimum and the sample maximum, respectively. The box plot is commonly used in open-high-low-close chart (OHLC) for illustrating price fluctuations of a financial instrument in a unit time. Since the box plot uses percentiles, the information that can be obtained out of the box plot shown in FIG. 2 only includes whether the distribution is symmetrical (not symmetrical in this case).

Shown in FIG. 3 is another example of the box plot where two fences are illustrated by dashed lines to the right of the box. The two fences respectively indicate an inner fence percentile equal to Q3+1.5×(Q3−Q1), and an outer fence percentile equal to Q3+3×(Q3−Q1). The whisker beyond the inner fence percentile is not displayed, and symbols, such as a hollow dot (∘) and a star ( [symbol] ), are used for indicating observations beyond the inner fence percentile and observations beyond the outer fence percentile (collectively referred to as “extreme observations” herein). In cases where there are data with negative values, there would be two fences to the left of the box, respectively indicating an inner fence percentile equal to Q1−1.5×(Q3−Q1), and an outer fence percentile equal to Q1−3×(Q3−Q1). As compared to the box plot of FIG. 2, the box plot of FIG. 3 presents additional information regarding the locations of extreme observations. However, the extreme observations are different in definition from the unusual observations and outliers of the Gaussian distribution, which are the commonly used reference in statistics. In other words, meanings of extreme observations with reference to Gaussian distribution cannot be known from the box plot.

Shown in FIG. 4 is a box plot for illustrating multiple sets of data. It is evident from FIG. 4 that to simultaneously present boxes and extreme data, the plot becomes difficult to read and interpret by a user, especially when the extreme observations are very distant from the boxes, where the boxes are compressed significantly.

Moreover, a shortcoming common to both dot plot and histogram is that, significant plot-generating and displaying resources are required when the data is large in quantity.

### SUMMARY OF THE INVENTION

Therefore, the object of the present invention is to provide a machine-implemented method and an electronic device for graphically illustrating a statistical display based on a set of numerical data, where the display is easy to read, requires little display resources, and is capable of providing objective meanings of extreme observations, and a computer program product for implementing the method.

According to one aspect of the present invention, there is provided a machine-implemented method for graphically illustrating a statistical display based on a set of numerical data. The machine-implemented method includes the steps of: (a) finding, with a processor, a median of the set of numerical data, and finding, with the processor, a subset of the numerical data, each corresponding to a member of a predetermined set of cumulative distribution probabilities of the Gaussian distribution; (b) computing, with the processor, a mean of the set of numerical data and a standard deviation of the set of numerical data; (c) computing, with the processor, a plurality of reference values, each differing from the mean of the set of numerical data by a corresponding predetermined number multiplied by the standard deviation of the set of numerical data; (d) generating, with the processor, a plot that includes a first line, a second line and a plurality of connecting lines, the first line extending in an axis direction and having the median and the subset of the numerical data found in step (a) marked thereon, the second line extending in the axis direction, being spaced apart from the first line, and having the mean and the reference values computed in step (c) marked thereon, the connecting lines respectively connecting the median and the mean, and corresponding pairs of the subset of the numerical data and the reference values; and (e) outputting the plot for viewing by a user.

According to another aspect of the present invention, there is provided a computer program product, including a computer readable storage medium that includes program instructions, which when executed by an electronic device, cause the electronic device to perform the above described method.

According to still another aspect of the present invention, there is provided an electronic device for graphically illustrating a statistical display based on a set of numerical data. The electronic device includes a data selecting unit, a computing unit, a plot generating unit, and an output unit.

The data selecting unit is for finding a median of the set of numerical data, and for finding a subset of the numerical data, each corresponding to a member of a predetermined set of cumulative distribution probabilities of the Gaussian distribution.

The computing unit is for computing a mean of the set of numerical data and a standard deviation of the set of numerical data, and for computing a plurality of reference values, each differing from the mean by a corresponding predetermined number multiplied by the standard deviation of the set of numerical data.

The plot generating unit is coupled to the data selecting unit and the computing unit for generating a plot that includes a first line, a second line and a plurality of connecting lines. The first line extends in an axis direction and has the median and the subset of the numerical data found by the data selecting unit marked thereon. The second line extends in the axis direction, is spaced apart from the first line, and has the mean and the reference values computed by the computing unit marked thereon. The connecting lines respectively connect the median and the mean, and corresponding pairs of the subset of the numerical data and the reference values.

The output unit is coupled to the plot generating unit for outputting the plot for viewing by a user.

The advantages and effects of the present invention lie in that it requires less plot-generating and displaying resources as compared to the conventional statistical graphs, such as dot plots and histograms, and that it presents more information regarding the distribution of the numerical data as compared to the conventional statistical graphs, such as the box plot.

### BRIEF DESCRIPTION OF THE DRAWINGS

Other features and advantages of the present invention will become apparent in the following detailed description of the preferred embodiments with reference to the accompanying drawings, of which:

FIG. 1 is a plot for illustrating a probability density function for a Gaussian distribution known in the prior art;

FIG. 2 is an example of a conventional box plot;

FIG. 3 is another example of the conventional box plot;

FIG. 4 is an example of the conventional box plot for illustrating multiple sets of data;

FIG. 5 is a block diagram, illustrating the first preferred embodiment of an electronic device for graphically illustrating a statistical display based on a set of numerical data according to the present invention;

FIG. 6 is a block diagram, illustrating the second preferred embodiment of an electronic device for graphically illustrating a statistical display based on a set of numerical data according to the present invention;

FIG. 7 is a flow chart, illustrating the first preferred embodiment of the machine-implemented method for graphically illustrating a statistical display based on a set of numerical data according to the present invention;

FIG. 8 is a plot, illustrating the statistical display generated using the machine-implemented method of the present invention;

FIG. 9 illustrates a table containing first and second sets of numerical data used for a first exemplary embodiment of the present invention;

FIG. 10 illustrates a table containing a median and a subset of numerical data for each of the first and second sets of numerical data of FIG. 9;

FIG. 11 illustrates a table containing a mean and a plurality of reference values for each of the first and second sets of numerical data of FIG. 9;

FIG. 12 is a plot, illustrating the statistical display generated for the first exemplary embodiment;

FIG. 13 illustrates a table containing first and second sets of numerical data used for a second exemplary embodiment of the present invention, which are natural logarithmic equivalents of the first and second sets of numerical data of FIG. 9;

FIG. 14 illustrates a table containing the median and the subset of numerical data for each of the first and second sets of numerical data of FIG. 13;

FIG. 15 illustrates a table containing the mean and the reference values for each of the first and second sets of numerical data of FIG. 13;

FIG. 16 is a plot, illustrating the statistical display generated for the second exemplary embodiment; and

FIG. 17 is a plot, illustrating the statistical display generated for a third exemplary embodiment of the present invention.

### DETAILED DESCRIPTION OF THE PREFERRED EMBODIMENTS

Before the present invention is described in greater detail, it should be noted that like elements are denoted by the same reference numerals throughout the disclosure.

With reference to FIG. 5, the first preferred embodiment of an electronic device 100 for graphically illustrating a statistical display based on a set of numerical data according to the present invention includes a processor 10, and a storage unit 11, an input unit 12 and an output unit 13 all coupled electrically to the processor 10. The processor 10 is for performing steps of the machine-implemented method for graphically illustrating a statistical display based on a set of numerical data according to the present invention. In particular, the processor 10 is capable of executing program instructions of a computer readable storage medium of a computer program product 110 that causes the processor 10 to perform steps of the machine-implemented method of the present invention. In addition, the storage unit 11 has a numerical database 111 and a parameter setting table 112 established therein.

The electronic device 100 can be, but is not limited to, a personal computer, a workstation, a notebook computer, a palmtop computer, data processing equipment, audiovisual equipment, personal digital assistant (PDA), etc.

The computer program product 110 may be written in programming languages such as C, Visual C++, Visual Basic, JAVA, etc. The processor 10 is a central processor in this embodiment. The input unit 12 permits input of the set of numerical data from an external data source 2, such as a host containing financial data, to the processor 10, which then stores the set of numerical data in the numerical database 111. The parameter setting table 112 may contain parameters that are pre-established or that are inputted by a user via the input unit 12. To associate operably with the external data source 2, the input unit 12 may be an Internet interface, or other transmission interfaces capable of communicating with the external data source 2, or may be a keyboard, a mouse, a remote controller, a voice recognition system, a touch panel of a mobile phone, etc. in cases where the set of numerical data is inputted by a user. The output unit 13 may include a display device (not shown) for displaying the plot 300. The output unit 13 can be a computer monitor, a TV screen, a display screen of a mobile phone, or a printer, as long as the statistical display may be viewed by the user in some way.

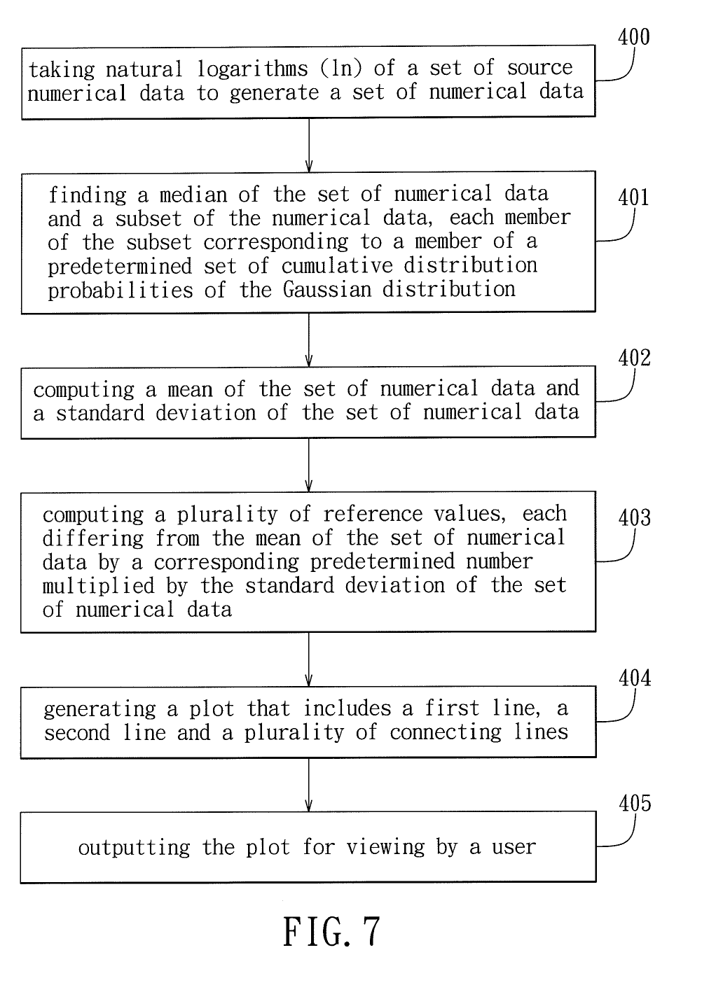

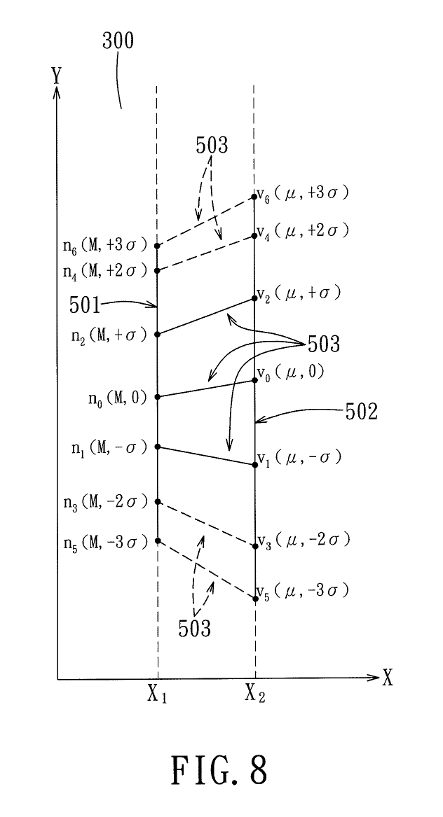

With reference to FIG. 7 and FIG. 8, the first preferred embodiment of the machine-implemented method for graphically illustrating a statistical display based on a set of numerical data according to the present invention includes the following steps.

In step 401, with the processor 10, a median (M) of the set of numerical data and a subset of the numerical data are found. Each member of the subset corresponds to a member of a predetermined set of cumulative distribution probabilities of the Gaussian distribution.

In step 402, with the processor 10, a mean (μ) of the set of numerical data and a standard deviation (σ) of the set of numerical data are computed.

In step 403, with the processor 10, a plurality of reference values are computed. Each of the reference values differs from the mean (μ) of the set of numerical data by a corresponding predetermined number multiplied by the standard deviation (σ) of the set of numerical data.

In step 404, with the processor 10, a plot 300 including a first line 501, a second line 502 and a plurality of connecting lines 503 is generated. The first line 501 extends in an axis direction and has the median (M) and the subset of the numerical data found in step 401 marked thereon. The second line 502 extends in the axis direction, is spaced apart from the first line 501, and has the mean (μ) and the reference values computed in step 403 marked thereon. The connecting lines 503 respectively connect the median (M) and the mean (μ), and corresponding pairs of the subset of the numerical data and the reference values.

In step 405, the plot 300 is outputted for viewing by a user. To facilitate viewing, the plot 300 may be outputted together with an X-axis and a Y-axis. In this embodiment, the Y-axis defines the axis direction. However, to satisfy the requirements and needs of particular applications, the X-axis, instead of the Y-axis, may also define the axis direction in other embodiments.

According to this embodiment, in step 401, the predetermined set of cumulative distribution probabilities includes first, second, third, fourth, fifth and sixth cumulative distribution probabilities. The first cumulative distribution probability (d₁) corresponds to a range of within one standard deviation smaller than the mean of the Gaussian distribution. The second cumulative distribution probability (d₂) corresponds to a range of within one standard deviation greater than the mean of the Gaussian distribution. The third cumulative distribution probability (d₃) corresponds to a range of within two standard deviations smaller than the mean of the Gaussian distribution. The fourth cumulative distribution probability (d₄) corresponds to a range of within two standard deviations greater than the mean of the Gaussian distribution. The fifth cumulative distribution probability (d₅) corresponds to a range of within to three standard deviations smaller than the mean of the Gaussian distribution. The sixth cumulative distribution probability (d₆) corresponds to a range of within three standard deviations greater than the mean of the Gaussian distribution.

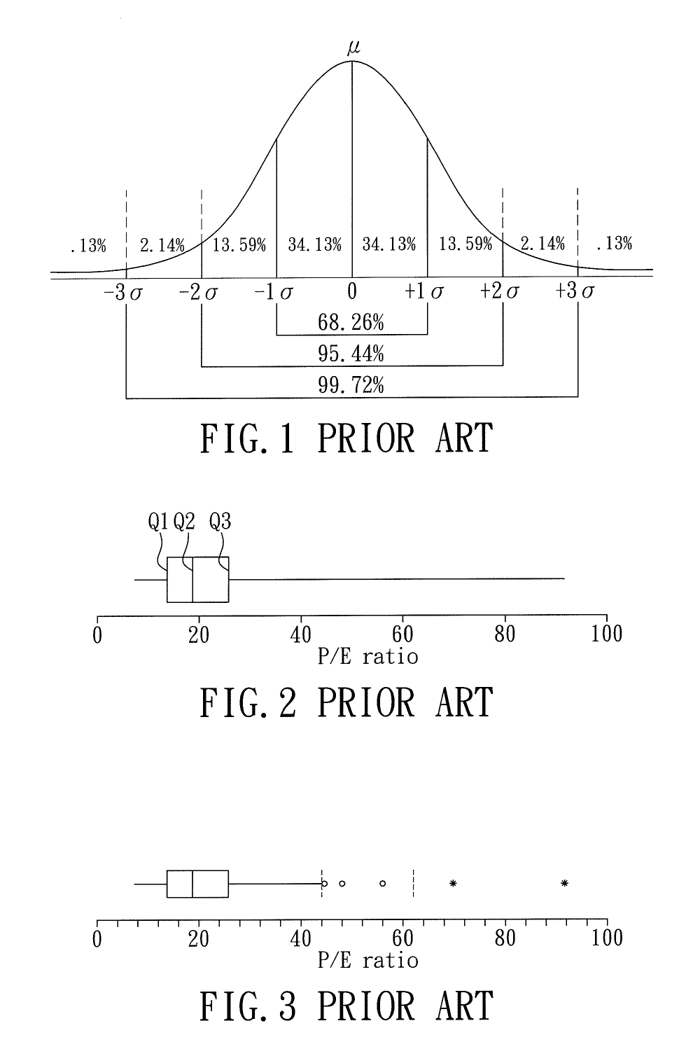

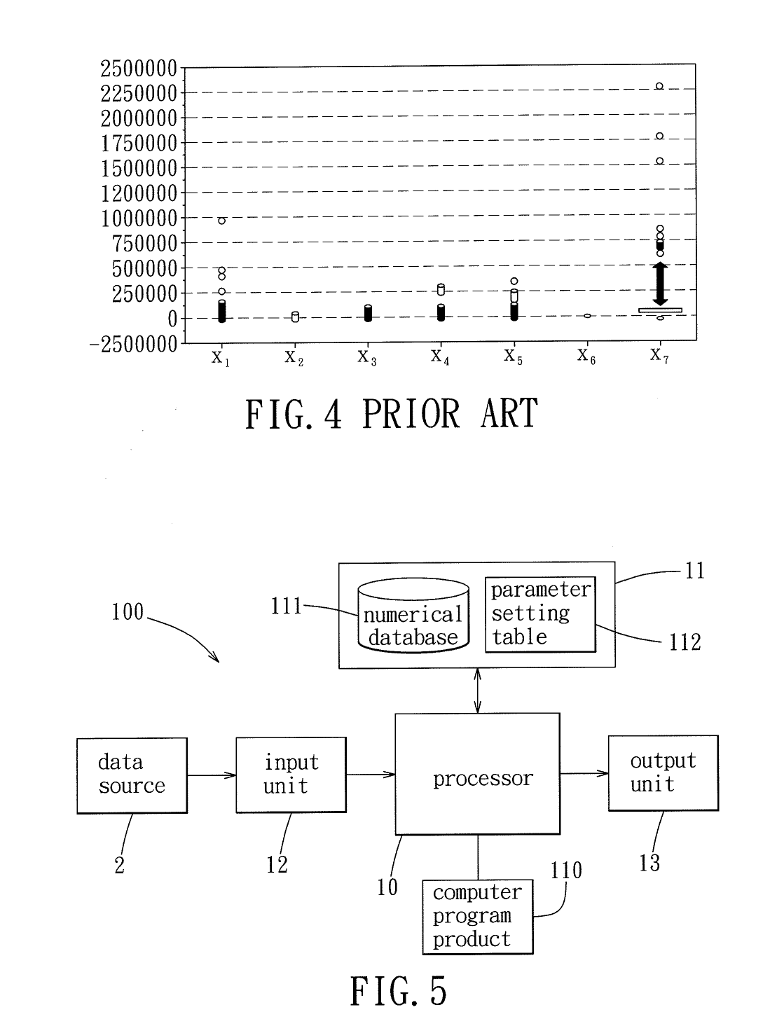

In particular, with reference to FIG. 1, the first cumulative distribution probability (d₁) can be computed as

$$\frac{1 - 68.26 \%}{2} = 15.87 \% ,$$

and the second cumulative distribution probability (d₂) can be computed as

$$\frac{1 + 68.26 \%}{2} = 84.13 \% ,$$

where 68.26% is the distribution probability within one standard deviation from the mean of the Gaussian distribution. The third cumulative distribution probability (d₃) can be computed as

$$\frac{1 - 95.44 \%}{2} = 2.28 \% ,$$

and the fourth cumulative distribution probability (d₄) can be computed as

$$\frac{1 + 95.44 \%}{2} = 97.72 \% ,$$

where 95.44% is the distribution probability within two standard deviations from the mean of the Gaussian distribution. The fifth cumulative distribution probability (d₅) can be computed as

$$\frac{1 - 99.73 \%}{2} = 0.135 \% ,$$

and the sixth cumulative distribution probability (d₆) can be computed as

$$\frac{1 + 99.73 \%}{2} = 99.87 \% ,$$

where 99.87% is the distribution probability within three standard deviations from the mean of the Gaussian distribution. The first, second, third, fourth, fifth and sixth cumulative distribution probabilities (d₁, d₂, d₃, d₄, d₅, d₆) may be pre-established in the parameter setting table 112.

Accordingly, the subset of the numerical data includes first, second, third, fourth, fifth and sixth members (n₁, n₂, n₃, n₄, n₅, n₆). The numerical order of the first member (n₁) of the subset among the set of the numerical data corresponds to the total number of the numerical data multiplied by the first cumulative distribution probability (d₁). The numerical order of the second member (n₂) of the subset among the set of the numerical data corresponds to the total number of the numerical data multiplied by the second cumulative distribution probability (d₂). The numerical order of the third member (n₃) of the subset among the set of the numerical data corresponds to the total number of the numerical data multiplied by the third cumulative distribution probability (d₃). The numerical order of the fourth member (n₄) of the subset among the set of the numerical data corresponds to the total number of the numerical data multiplied by the fourth cumulative distribution probability (d₄). The numerical order of the fifth member (n₅) of the subset among the set of the numerical data corresponds to the total number of the numerical data multiplied by the fifth cumulative distribution probability (d₅). The numerical order of the sixth member (n₆) of the subset among the set of the numerical data corresponds to the total number of the numerical data multiplied by the sixth cumulative distribution probability (d₆).

In particular, the subset of the numerical data is found in the following way. Assuming the total number of the numerical data in the set is (k), with six cumulative distribution probabilities (d₁˜d₆), six intermediate values (i₁˜i₆) can be obtained through the following equation k·dₓ=iₓ, where (x) is an integer between 1 and 6. Each of the first to sixth members (n₁˜n₆) of the subset of numerical data is found by selecting, among the set of numerical data, a member whose numerical order is the closest integer to a corresponding one of the intermediate values (i₁˜i₆).

Moreover, the reference values computed in step 403 include first, second, third, fourth, fifth and sixth reference values (v₁˜v₆). The first reference value (v₁) is smaller than the mean (μ) of the set of numerical data by one standard deviation (σ) of the set of numerical data. The second reference value (v₂) is greater than the mean (μ) of the set of numerical data by one standard deviation (σ) of the set of numerical data. The third reference value (v₃) is smaller than the mean (μ) of the set of numerical data by two standard deviations (σ) of the set of numerical data. The fourth reference value (v₄) is greater than the mean (μ) of the set of numerical data by two standard deviations (σ) of the set of numerical data. The fifth reference value (v₅) is smaller than the mean (μ) of the set of numerical data by three standard deviations (σ) of the set of numerical data. The sixth reference value (v₆) is greater than the mean (μ) of the set of numerical data by three standard deviations (σ) of the set of numerical data.

It should be noted herein that, since the predetermined set of cumulative distribution probabilities is defined to include cumulative distribution probabilities that correspond to ranges of within integer multiples of the standard deviation smaller/greater than the mean of the Gaussian distribution, the reference values are also defined to differ from the mean (μ) by integer multiples of the standard deviation (σ) of the set of numerical data. However, the present invention also encompasses those applications where the cumulative distribution probabilities correspond to ranges whose upper limits are smaller/greater than the mean of the Gaussian distribution by values computed by multiplying non-integers by the standard deviation of the Gaussian distribution. In such cases, the reference values are also defined to differ from the mean (μ) of the set of numerical data by non-integers multiplied by the standard deviation (σ) of the set of numerical data.

Further, the plot 300 generated in step 404 includes seven of the connecting lines 503, respectively connecting the median (M) to the mean (μ), and the first, second, third, fourth, fifth and sixth members (n₁˜n₆) of the subset of numerical data respectively to the first, second, third, fourth, fifth and sixth reference values (v₁˜v₆). Preferably, the connecting lines 503 that connect the median (M) to the mean (μ), the first member (n₁) of the subset of numerical data to the first reference value (v₁), and the second member (n₂) of the subset of numerical data to the second reference value (v₂) are shown in solid lines, while the connecting lines 503 that connect the third, fourth, fifth and sixth members (n₃˜n₆) of the subset of numerical data respectively to the third, fourth, fifth and sixth reference values (v₃˜v₆) are shown in dashed lines when outputted for viewing by the user.

Preferably, among the points marked on the first and second lines 501, 502, if there is one which is numerically distant from the mean (μ) by more than twice the standard deviation (σ), it will be marked using a (⊙) symbol, and is referred to as an unusual observation when the set of numerical data has a Gaussian distribution, and if there is one which is numerically distant from the mean (μ) by more than three times the standard deviation (σ), it will be marked using a (*) symbol, and is referred to as an outlier when the set of numerical data has a Gaussian distribution. Otherwise, the points are marked using a () symbol.

When reading the plot 300 generated according to the present invention, the more the connecting lines 503 approach a perpendicular relationship relative to the axis direction (Y), the more likely that the set of numerical data has a Gaussian (normal) distribution. In particular, if a group of the connecting lines 503 are approximately perpendicular to the axis direction while the rest of the connecting lines 503 are not, statistical analysis and estimations based on the Gaussian distribution may be applied to values close to the points to which the connecting lines 503 of the group are connected, while statistical analysis and estimations based on the Gaussian distribution are not applicable to the values close to the points to which the rest of the connecting lines 503 are connected.

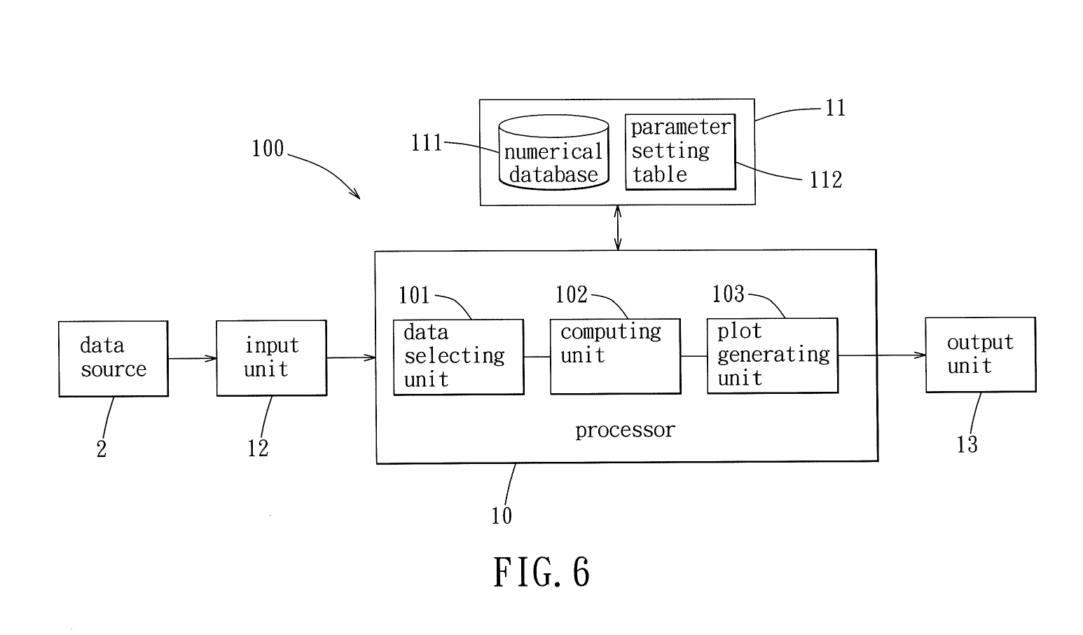

Alternatively, with reference to FIG. 6, the second preferred embodiment of an electronic device 100 for graphically illustrating a statistical display based on a set of numerical data according to the present invention differs from the first preferred embodiment in that the processor 10 includes a data selecting unit 101, a computing unit 102 and a plot generating unit 103. The data selecting unit 101 finds the median (M) of the set of numerical data, and further finds the subset of the numerical data, each corresponding to a member of the predetermined set of cumulative distribution probabilities of the Gaussian distribution. The computing unit 102 computes the mean (μ) and the standard deviation (σ) of the set of numerical data, and computes the plurality of reference values. Each of the reference values differs from the mean (μ) by a corresponding predetermined number multiplied by the standard deviation (σ) of the set of numerical data. The plot generating unit 103 is coupled to the data selecting unit 101 and the computing unit 102 for generating the plot 300 (shown in FIG. 8). The output unit 13 is coupled to the plot generating unit 103 for outputting the plot 300 for viewing by the user.

The present invention will be better understood with reference to the following exemplary embodiments.

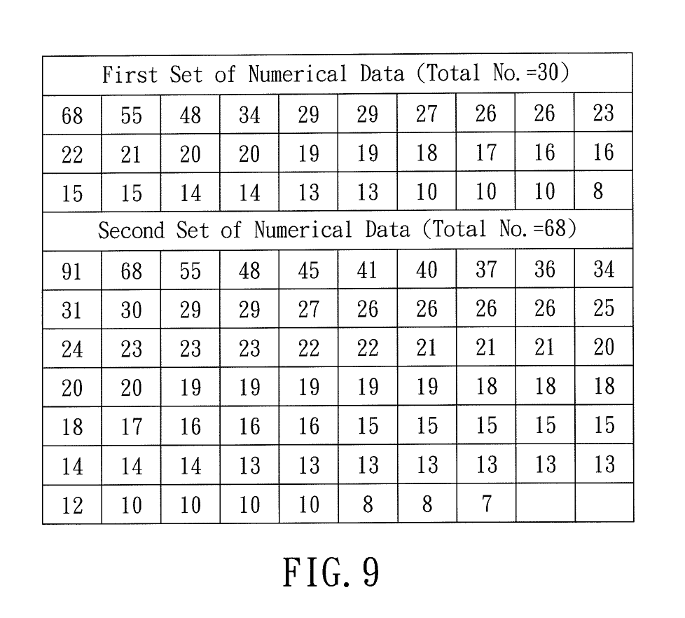

With reference to FIG. 9, the first exemplary embodiment includes two sets of numerical data, namely a first set having a total number of numerical data of (k₁=30), and a second set having a total number of numerical data of (k₂=68). The first and second sets of numerical data respectively include profit/earnings (P/E) ratios of stocks of 30 and 68 companies.

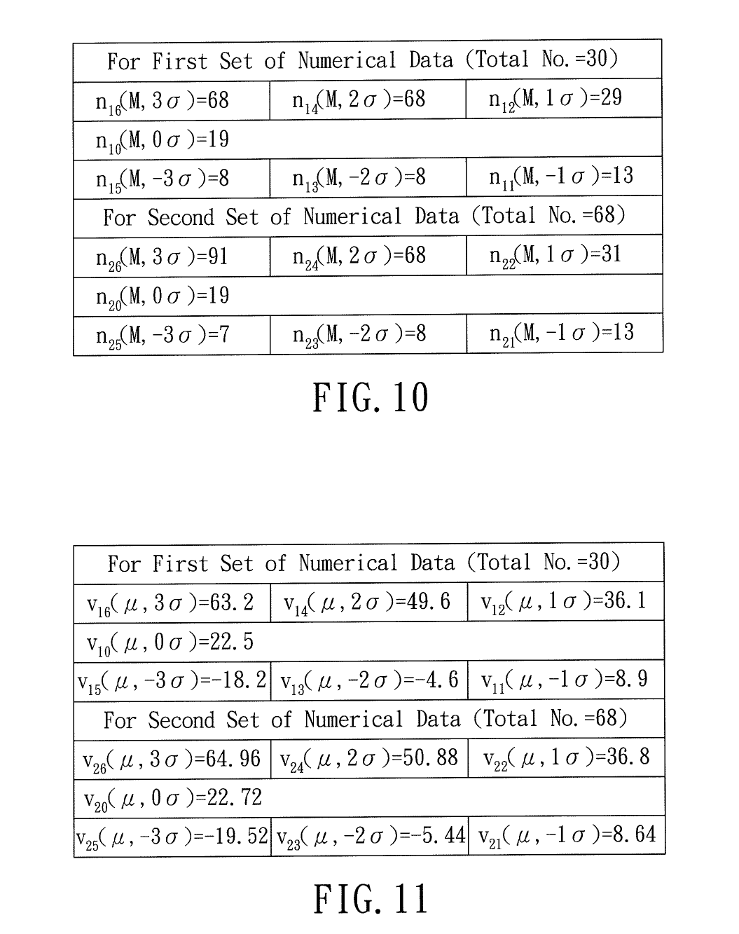

According to step 401, the median (M) and the subset of the numerical data are found for each of the first and second sets of numerical data. As shown in FIG. 10, the median (M) for the first set of numerical data is denoted by n₁₀(M, 0σ) and is equal to 19, and the median (M) for the second set of numerical data is denoted by n₂₀(M, 0σ) and is equal to 19. With the first, second, third, fourth, fifth and sixth cumulative distribution probabilities (d₁, d₂, d₃, d₄, d₅, d₆) defined as previously described, i.e., 15.87%, 84.13%, 2.28%, 97.72%, 0.135% and 99.87%, the subset of numerical data for the first set includes first, second, third, fourth, fifth and sixth members n₁₁(M, −1σ), n₁₂(M, 1σ), n₁₃(M, −2σ), n₁₄(M, 2σ), n₁₅(M, −3σ), n₁₆(M, 3σ) that respectively equal to 13, 29, 8, 68, 8 and 68, and the subset of numerical data for the second set includes first, second, third, fourth, fifth and sixth members n₂₁(M, −1σ), n₂₂(M, 1σ), n₂₃(M, −2σ), n₂₄(M, 2σ) n₂₅(M, −3σ), n₂₆(M, 3σ) that are respectively equal to 13, 31, 8, 68, 7 and 91.

Taking the first set of numerical data for illustration, since the total number (k₁) of the numerical data in the first set is 30, the median n₁₀(M, 0σ) is the numerical data whose numerical order corresponds to approximately half of the total number (k₁), i.e., 15 or 16. In this embodiment, the median n₁₀(M, 0σ) is taken to be the 15^{th} numerical data in ascending order, and has the value of 19. It should be noted herein that the numerical data shown in FIG. 9 are arranged in numerical order for easy reference. The first member n₁₁(M, −1σ) of the subset is found by first obtaining the corresponding intermediate value i₁₁=k₁·d₁=30·15.87%=4.761, and with 5 being the closest integer to i₁₁, locating the 5^{th} numerical data in ascending order to be the first member n₁₁(M, −1σ) of the subset. The second member n₁₂(M, 1σ) of the subset is found by obtaining the corresponding intermediate value i₁₂=k₁·d₂=30·84.130=25.239, and with 25 being the closest integer to i₁₂, locating the 25^{th} numerical data in ascending order to be the second member n₁₂(M, 1σ) of the subset. The rest of the members of the subset for the first set of numerical data, and members of the subset for the second set of numerical data are found in a similar fashion, and further details of the same are omitted herein for the sake of brevity.

According to step 402, the mean (μ) and the standard deviation (σ) of each of the first and second sets of numerical data are computed. The mean (μ) is computed by dividing the sum of all numerical data in the set with the total number (k) of the numerical data, and the standard deviation (σ) is computed using a standard formula of

$$σ = \sqrt{\frac{1}{k - 1} {\sum }_{i = 1}^{k} [ {x}_{i} - μ ]} .$$

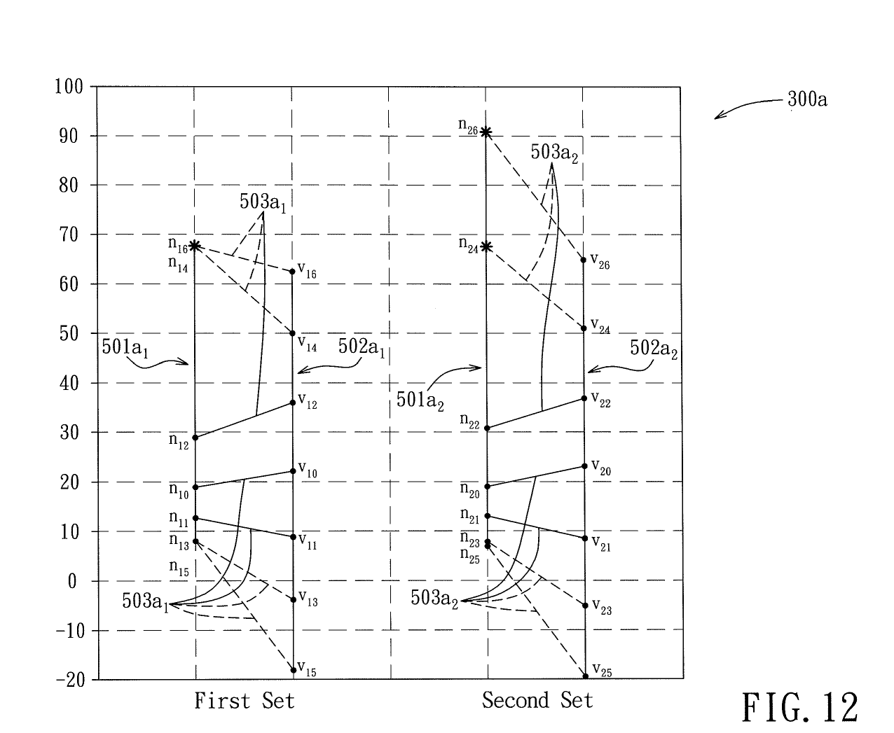

Accordingly, for the first set of numerical data, the mean (μ1), which is denoted by v₁₀(μ, 0σ) in FIG. 11, is computed to be 22.5, and the standard deviation (σ1) is computed as

$$σ 1 = \sqrt{\frac{1}{{k}_{1} - 1} {\sum }_{i = 1}^{{k}_{1}} [ {x}_{i} - 22.5 ]} = \sqrt{\frac{1}{29} {\sum }_{i = 1}^{30} [ {x}_{i} - 22.5 ]} = 13.5564 .$$

In addition, for the second set of numerical data, the mean (μ2), which is denoted by v₂₀(μ, 0σ) in FIG. 11, is computed to be 22.72, while the standard deviation (σ2) is computed as

$$σ 2 = \sqrt{\frac{1}{{k}_{2} - 1} {\sum }_{i = 1}^{{k}_{2}} [ {x}_{i} - 22.72 ]} = \sqrt{\frac{1}{67} {\sum }_{i = 1}^{68} [ {x}_{i} - 22.72 ]} = 14.0827 .$$

According to step 403, the plurality of reference values are computed for each of the first and second sets of numerical data. As described earlier, the plurality of reference values for the first set of numerical data include the first, second, third, fourth, fifth and sixth reference values v₁₁(μ, −1σ), v₁₂(μ, 1σ), v₁₃(μ, −2σ), v₁₄(μ, 2σ), v₁₅(μ, −3σ), v₁₆(μ, 3σ) that are respectively equal to 8.9, 36.1, −4.6, 49.6, −18.2 and 63.2, and the plurality of reference values for the second set of numerical data include the first, second, third, fourth, fifth and sixth reference values v₂₁(μ, −1σ), v₂₂(μ, 1σ), v₂₃(μ, −2σ), v₂₄(μ, 2σ), v₂₅(μ, −3σ), v₂₆(μ, 3σ) that are respectively equal to 8.64, 36.8, −5.44, 50.88, −19.52 and 64.96.

Taking the first set of numerical data for illustration, the first reference value v₁₁(μ, −1σ) is computed as μ−1σ=22.5-13.5564=8.9, the second reference value v₁₂(μ, 1σ) is computed as μ+1σ=22.5+13.5564=36.1, the third reference value v₁₃(μ, −2σ) is computed as μ−2σ=22.5−2×13.5564=−4.6, the fourth reference value v₁₄(μ, 2σ) is computed as μ+2σ=22.5+2×13.5564=49.6, the fifth reference value v₁₅(μ, −3σ) is computed as μ−3σ=22.5−3×13.5564=−18.2, and the sixth reference value v₁₆(μ, 3σ) is computed as μ+3σ=22.5+3×13.5564=63.2. The reference values for the second set of numerical data are found in a similar fashion, and further details of the same are omitted herein for the sake of brevity.

According to step 404, the plot 300a shown in FIG. 12 is generated. For this particular exemplary embodiment, since there are two sets of numerical data, the plot 300a includes two sets of first, second and connecting lines 501a₁, 501a₂, 502a₁, 502a₂, 503a₁, 503a₂. On the first line 501a₁ corresponding to the first set of numerical data, there are marked the median n₁₀, and the members of the subset of numerical data n₁₁, n₁₂, n₁₃, n₁₄, n₁₅, n₁₆. On the second line 502a₁ corresponding to the first set of numerical data, there are marked the mean v₁₀, and the reference values v₁₁, v₁₂, v₁₃, v₁₄, v₁₅, v₁₆. Three solid connecting lines 503a₁ respectively connect the median n₁₀ to the mean v₁₀, the first member n₁₁ of the subset to the first reference value v₁₁, and the second member of the subset n₁₂ to the second reference value v₁₂. Four dashed connecting lines 503a₁ respectively connect the third member of the subset n₁₃ to the third reference value v₁₃, the fourth member of the subset n₁₄ to the fourth reference value v₁₄, the fifth member of the subset n₁₅ to the fifth reference value v₁₅, and the sixth member of the subset n₁₆ to the sixth reference value v₁₆. Similarly, on the first line 501a₂ corresponding to the second set of numerical data, there are marked the median n₂₀, and the members of the subset of numerical data n₂₁, n₂₂, n₂₃, n₂₄, n₂₅, n₂₆. On the second line 502a₂ corresponding to the second set of numerical data, there are marked the mean v₂₀, and the reference values v₂₁, v₂₂, v₂₃, v₂₄, v₂₅, v₂₆. Three solid connecting lines 503a₂ respectively connect the median n₂₀ to the mean v₂₀, the first member n₂₁ of the subset to the first reference value v₂₁, and the second member of the subset n₂₂ to the second reference value v₂₂. Four dashed connecting lines 503a₂ respectively connect the third member of the subset n₂₃ to the third reference value v₂₃, the fourth member of the subset n₂₄ to the fourth reference value v₂₄, the fifth member of the subset n₂₅ to the fifth reference value v₂₅, and the sixth member of the subset n₂₆ to the sixth reference value v₂₆.

It is noted herein that since n₁₄ and n₁₆ are greater than v₁₆, i.e., that n₁₄ and n₁₆ are numerically distant from the mean (μ1) by more than three times the standard deviation (σ1), these two points are considered outliers if the first set of numerical data has a Gaussian distribution and are marked using the ( [symbol] ) symbol, and since n₂₄ and n₂₆ are greater than v₂₆, i.e., that n₂₄ and n₂₆ are numerically distant from the mean (μ2) by more than three times the standard deviation (σ2), these two points are considered outliers if the second set of numerical data has a Gaussian distribution and are marked using the ( [symbol] ) symbol.

As is evident from FIG. 12, the means v₁₀, v₂₀ and the standard deviations (σ1, σ2) of the first and second sets of numerical data are approximately the same, and the distributions of the first and second sets of numerical data are also approximately the same. In particular, none of the first and second sets of numerical data is normally (Gaussian) distributed. Instead, the first and second sets of numerical data are positively-skewed with the long tail on the positive side.

In the alternative, the second preferred embodiment of a machine-implemented method for graphically illustrating a statistical display based on a set of numerical data according to the present invention differs from the first preferred embodiment in that the plot 300 is presented in a logarithmic scale. The machine-implemented method of the second preferred embodiment further includes, prior to step 401, step 400, where, with the processor 10, natural logarithms (1n) of a set of source numerical data are taken so as to generate the set of numerical data used in the subsequent steps. Alternatively, in the absence of step 400, the set of numerical data may be a natural logarithmic equivalent of a set of source numerical data. This is especially useful when the set of source numerical data involve financial stats, such as P/E ratios, or for applications in the analysis of operational risks (e.g., key risk indicator (KRI)) and investments.

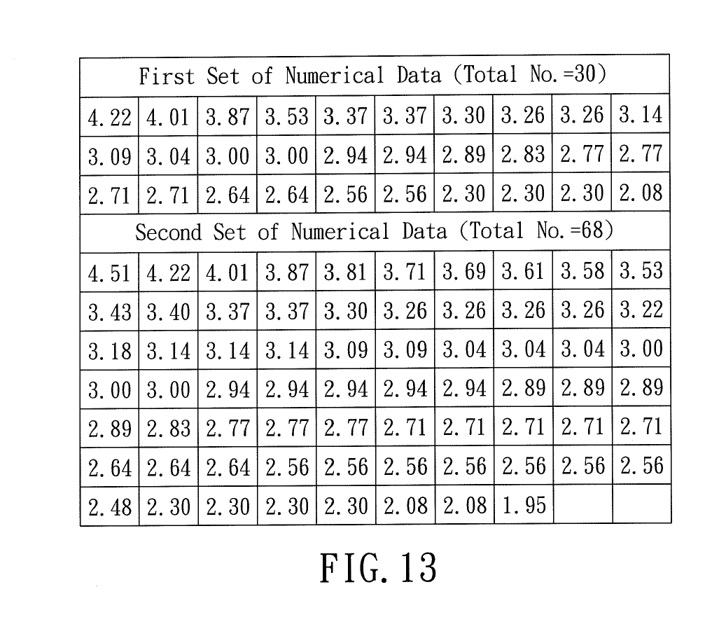

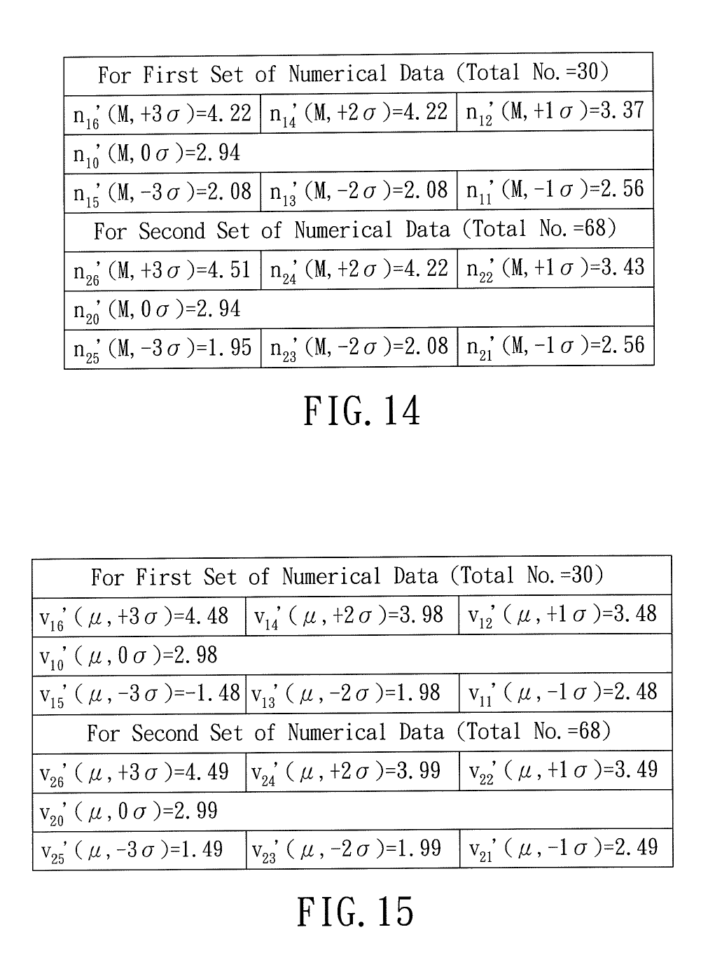

Accordingly, with reference to FIG. 13, the second exemplary embodiment includes two sets of numerical data that are respectively natural logarithmic equivalents of the first and second sets of numerical data used in the previous exemplary embodiment. In other words, the first and second sets of numerical data used in the first exemplary embodiment are respectively first and second sets of source numerical data for the second exemplary embodiment. Shown in FIG. 14 are the medians n₁₀′, n₂₀′ and the members of the subsets of numerical data n₁₁′, n₁₂′, n₁₃′, n₁₄′, n₁₅′, n₁₆′, n₂₁′, n₂₂′, n₂₃′, n₂₄′, n₂₅′, n₂₆′ for the first and second sets of numerical data shown in FIG. 13 as found in the manner described with reference to the first exemplary embodiment. Shown in FIG. 15 are the means v₁₀′, v₂₀′ and the reference values v₁₁′, v₁₂′, v₁₃′, v₁₄′, v₁₅′, v₁₆′, v₂₁′, v₂₂′v₂₃′, v₂₄′, v₂₅′, v₂₆′ for the first and second sets of numerical data shown in FIG. 13 as computed in the manner described with reference to the first exemplary embodiment.

It is noted herein that since n₁₄′ and n₁₆′ are greater than v₁₄′, i.e., that n₁₄′ and n₁₆′ are numerically distant from the mean v₁₀′ by more than twice the standard deviation, these two points are considered unusual observations if the first set of numerical data has a Gaussian distribution and are marked using the (⊙) symbol. For a similar reason, n₂₄′ is considered an unusual observation if the second set of numerical data has a Gaussian distribution, and is marked using the (⊙) symbol. Moreover, since n₂₆′ is greater than v₂₆′, i.e., n₂₆′ is numerically distant from the mean v₂₀′ by more than three times the standard deviation, this point is considered an outlier if the second set of numerical data has a Gaussian distribution and is marked using the ( [symbol] ) symbol.

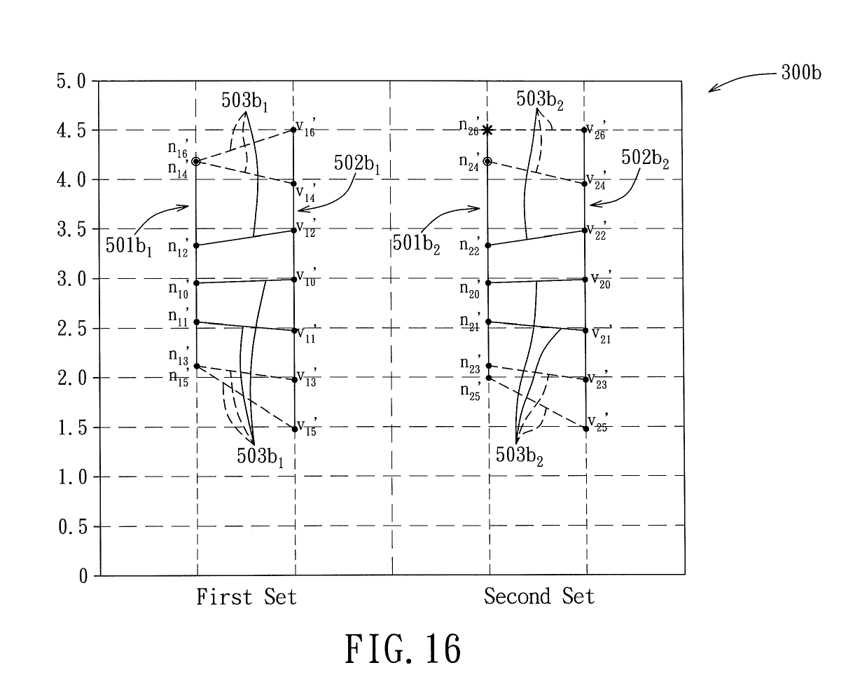

The plot 300b shown in FIG. 16 is generated for the second exemplary embodiment, where there are two sets of first, second and connecting lines 501b₁, 501b₂, 502b₁, 502b₂, 503b₁, 503b₂. On the first line 501b₁ corresponding to the first set of numerical data, there are marked the median n₁₀′, and the members of the subset of numerical data n₁₁′, n₁₂′, nₙ′, n₁₄′, n₁₅′, n₁₆′. On the second line 502b₁ corresponding to the first set of numerical data, there are marked the mean v₁₀′, and the reference values v₁₁′, v₁₂′, v₁₃′, v₁₄′, v₁₅′, v₁₆′. Three solid connecting lines 503b₁ respectively connect the median n₁₀′ to the mean v₁₀′, the first member n₁₁′ of the subset to the first reference value v₁₁′, and the second member of the subset n₁₂′ to the second reference value v₁₂′. Four dashed connecting lines 503b₁ respectively connect the third member of the subset n₁₃′ to the third reference value v₁₃′, the fourth member of the subset n₁₄′ to the fourth reference value v₁₄′, the fifth member of the subset n₁₅′ to the fifth reference value v₁₅′, and the sixth member of the subset n₁₆′ to the sixth reference value v₁₆′. Similarly, on the first line 501b₂ corresponding to the second set of numerical data, there are marked the median n₂₀′, and the members of the subset of numerical data n₂₁′, n₂₂′, n₂₃′, n₂₄′, n₂₅′, n₂₆′. On the second line 502b₂ corresponding to the second set of numerical data, there are marked the mean v₂₀′, and the reference values v₂₁′, v₂₂′, v₂₃′, v₂₄′, v₂₅′, v₂₆′. Three solid connecting lines 503b₂ respectively connect the median n₂₀′ to the mean v₂₀′, the first member n₂₁′ of the subset to the first reference value v₂₁′, and the second member of the subset n₂₂′ to the second reference value v₂₂′. Four dashed connecting lines 503b₂ respectively connect the third member of the subset n₂₃′ to the third reference value v₂₃′, the fourth member of the subset n₂₄′ to the fourth reference value v₂₄′, the fifth member of the subset n₂₅′ to the fifth reference value v₂₅′, and the sixth member of the subset n₂₆′ to the sixth reference value v₂₆′.

As is evident in FIG. 16, the solid connecting lines 503b₁ corresponding to the first set of numerical data and respectively connecting the median n₁₀′ to the mean v₁₀′, the first member of the subset of numerical data n₁₁′ to the first reference value v₁₁′, and the second member of the subset of numerical data n₁₂′ to the second reference value v₁₂¹, as well as the dashed connecting line 503b₁ corresponding to the first set of numerical data and connecting the third member of the subset of numerical data n₁₃′ to the third reference value v₁₃′ direction (Y). Therefore, in the range between one standard deviation greater than the mean v₁₀′ and two standard deviations smaller than the mean v₁₀′, the first set of numerical data exhibits a distribution proximate to the Gaussian distribution. Under the Gaussian distribution, this range encompasses roughly 82% of the distribution probability. Since the first set of numerical data is the natural logarithmic equivalent of the first set of source numerical data (i.e., the first set of numerical data for the first exemplary embodiment), the first set of source numerical data may be said to have a lognormal distribution in the range. A similar observation may be found for the second set of numerical data with reference to FIG. 16.

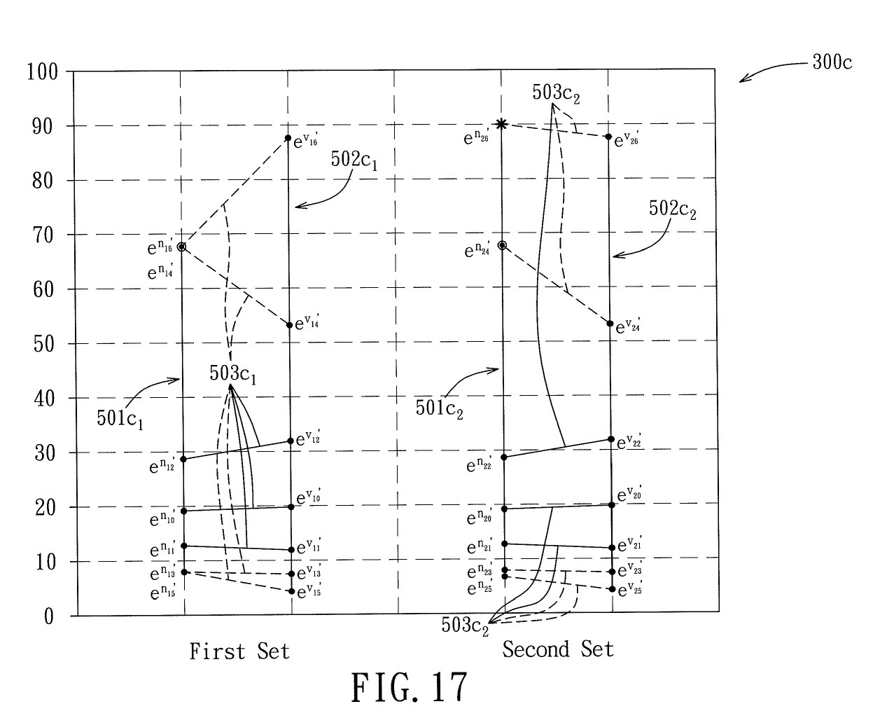

With reference to FIG. 17, in the third exemplary embodiment of the present invention, the plot 300c is obtained by directly plotting exponentials of the medians n₁₀′, n₂₀′, the members of the subsets of numerical data n₁₁′, n₁₂′, n₁₃′, n₁₄′, n₁₅′, n₁₆′, n₂₁′, n₂₂′, n₂₃′, n₂₄′, n₂₅′, n₂₆′, the means v₁₀′, v₂₀′, and the reference values v₁₁′, v₁₂′, v₁₃′, v₁₄′, v₁₅′, v₁₆′, v₂₁′, v₂₂′, v₂₃′, v₂₄′, v₂₅′, v₂₆′ for the first and second sets of numerical data of the second exemplary embodiment. Therefore, points eⁿ^{₁₀}′, eⁿ^{₁₁}′, eⁿ^{₁₂}′, eⁿ^{₁₃}′, eⁿ^{₁₄}′, eⁿ^{₁₅}′, and eⁿ^{₁₆}′ are marked on the first line 501c₁, and points e^{v}^{₁₀}′, e^{v}^{₁₁}′, e^{v}^{₁₂}′, e^{v}^{₁₃}′, e^{v}^{₁₄}′, e^{v}^{₁₅}′ and e^{v}^{₁₆}′ are marked on the second line 502c₁ corresponding to the first set of numerical data, and points eⁿ^{₂₀}′, eⁿ^{₂₁}′, eⁿ^{₂₂}′, eⁿ^{₂₃}′, eⁿ^{₂₄}′, eⁿ^{₂₅}′ and eⁿ^{₂₆}′ are marked on the first line 501c₂, endpoints e^{v}^{₂₀}′, e^{v}^{₂₁}′, e^{v}^{₂₂}′, e^{v}^{₂₃}′, e^{v}^{₂₄}′, e^{v}^{₂₅}′ and e^{v}^{₂₆}′ are marked on the second line 502c₂ corresponding to the second set of numerical data.

Since and eⁿ^{₁₄}′ and eⁿ^{₁₆}′ are greater than e^{v}′, these two points are marked using the (⊙) symbol. For a similar reason, eⁿ^{₂₄}′ is also marked using the (⊙) symbol. Moreover, since eⁿ^{₂₆}′ is greater than e^{v}^{₂₆}′, this point is marked using the ( [symbol] ) symbol.

As is evident in FIG. 17, the second to fifth connecting lines 503c₁ counting from the bottom of FIG. 17 and corresponding to the first set of numerical data are all approximately perpendicular to the axis direction (Y). Therefore, in the range between eⁿ^{₁₃}′ and eⁿ^{₁₂}′, all critical points of the first set of numerical data exhibits an exponential distribution, which encompasses roughly 82% of the lognormal distribution probability. A similar observation may be found for the second set of numerical data with reference to FIG. 17.

With reference to FIGS. 12-17, the third exemplary embodiment in essence brings the critical values (i.e., median, members of the subset, mean, reference values) of each of the first and second sets of numerical data from the natural logarithmic scale (as shown in FIG. 16) back into the scale shown in FIG. 12. However, FIG. 17 differs from FIG. 12 in that the critical values marked on the plot 300a of FIG. 12 are determined using the data shown in FIG. 9, while the critical values marked on the plot 300c of FIG. 17 are determined using the data shown in FIG. 13 and converted back into the scale of FIG. 12. This technique is useful when, as in FIG. 12, the distributions of the data are clearly not Gaussian distributions and cannot be analyzed using statistical tools, but a range of values might be found to correspond to log normal distribution and can be analyzed using statistical tools in the logarithmic scale.

It should be noted herein that although the above exemplary embodiments are presented as applications in investment and finance, the present invention is not limited to such applications, and can be used for analyzing numerical data of any nature. It should also be noted herein that the present invention is not limited to the degree of approximations taken for the determinations of the median, the subset of numerical data, the mean, the standard deviations, and the reference values.

In summary, the present invention provides a machine-implemented method and an electronic device for graphically illustrating a statistical display based on a set of numerical data, and a computer program product for implementing the method, where the statistical display is easy to read, requires little display resources (as compared to dot plots and histograms, especially when the data is large in quantity), and is capable of providing objective meanings of extreme observations (as compared to bar plots).

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A machine-implemented method for graphically illustrating a statistical display based on a set of numerical data, comprising the steps of:
(a) finding, with a processor, a median of the set of numerical data, and finding, with the processor, a subset of the numerical data, each corresponding to a member of a predetermined set of cumulative distribution probabilities of the Gaussian distribution;
(b) computing, with the processor, a mean of the set of numerical data and a standard deviation of the set of numerical data;
(c) computing, with the processor, a plurality of reference values, each differing from the mean of the set of numerical data by a corresponding predetermined number multiplied by the standard deviation of the set of numerical data;
(d) generating, with the processor, a plot that includes a first line, a second line and a plurality of connecting lines, the first line extending in an axis direction and having the median and the subset of the numerical data found in step (a) marked thereon, the second line extending in the axis direction, being spaced apart from the first line, and having the mean and the reference values computed in step (c) marked thereon, the connecting lines respectively connecting the median and the mean, and corresponding pairs of the subset of the numerical data and the reference values; and
(e) outputting the plot for viewing by a user.

2. The machine-implemented method for graphically illustrating a statistical display based on a set of numerical data as claimed in claim 1, wherein:
in step (a), the predetermined set of cumulative distribution probabilities includes a first cumulative distribution probability that corresponds to a range of within one standard deviation smaller than the mean of the Gaussian distribution, and a second cumulative distribution probability that corresponds to a range of within one standard deviation greater than the mean of the Gaussian distribution;
the subset of the numerical data includes a first one of the numerical data, whose numerical order among the set of the numerical data corresponds to the total number of the numerical data multiplied by the first cumulative distribution probability, and a second one of the numerical data, whose numerical order among the set of the numerical data corresponds to the total number of the numerical data multiplied by the second cumulative distribution probability;
the reference values computed in step (c) include a first reference value that is smaller than the mean by one standard deviation of the set of numerical data, and a second reference value that is greater than the mean by one standard deviation of the set of numerical data; and
the connecting lines connect the first and second ones of the numerical data respectively to the first and second reference values in step (d).

3. The machine-implemented method for graphically illustrating a statistical display based on a set of numerical data as claimed in claim 2, wherein:
in step (a), the predetermined set of cumulative distribution probabilities further includes a third cumulative distribution probability that corresponds to a range of within two standard deviations smaller than the mean of the Gaussian distribution, and a fourth cumulative distribution probability that corresponds to a range of within two standard deviations greater than the mean of the Gaussian distribution;
the subset of the numerical data further includes a third one of the numerical data, whose numerical order among the set of the numerical data corresponds to the total number of the numerical data multiplied by the third cumulative distribution probability, and a fourth one of the numerical data, whose numerical order among the set of the numerical data corresponds to the total number of the numerical data multiplied by the fourth cumulative distribution probability;
the reference values computed in step (c) further include a third reference value that is smaller than the mean by two standard deviations of the set of numerical data, and a fourth reference value that is greater than the mean by two standard deviations of the set of numerical data; and
the connecting lines connect the third and fourth ones of the numerical data respectively to the third and fourth reference values in step (d).

4. The machine-implemented method for graphically illustrating a statistical display based on a set of numerical data as claimed in claim 3, wherein:
in step (a), the predetermined set of cumulative distribution probabilities further includes a fifth cumulative distribution probability that corresponds to a range of within three standard deviations smaller than the mean of the Gaussian distribution, and a sixth cumulative distribution probability that corresponds to a range of within three standard deviations greater than the mean of the Gaussian distribution;
the subset of the numerical data further includes a fifth one of the numerical data, whose numerical order among the set of the numerical data corresponds to the total number of the numerical data multiplied by the fifth cumulative distribution probability, and a sixth one of the numerical data, whose numerical order among the set of the numerical data corresponds to the total number of the numerical data multiplied by the sixth cumulative distribution probability;
the reference values computed in step (c) further include a fifth reference value that is smaller than the mean by three standard deviations of the set of numerical data, and a sixth reference value that is greater than the mean by three standard deviations of the set of numerical data; and
the connecting lines connect the fifth and sixth ones of the numerical data respectively to the fifth and sixth reference values in step (d).

5. The machine-implemented method for graphically illustrating a statistical display based on a set of numerical data as claimed in claim 1, wherein the plot is presented in a logarithmic scale, the machine-implemented method further comprising, prior to step (a), the step of:
(f) with the processor, taking natural logarithms of a set of source numerical data to generate the set of numerical data.

6. The machine-implemented method for graphically illustrating a statistical display based on a set of numerical data as claimed in claim 5, further comprising, between steps (c) and (d), the step of (g) taking exponentials of the median, the subset of the numerical data found in step (a), the mean, and the reference values computed in step (c);
wherein in step (d), instead of the median and the subset of the numerical data found in step (a), the first line of the plot has the exponentials of the median and the subset of the numerical data resulting from step (g) marked thereon, and instead of the mean and the reference values computed in step (c), the second line of the plot has the exponentials of the mean and the reference values resulting from step (g) marked thereon, the connecting lines respectively connecting the exponentials of the median and the mean, and the exponentials of the corresponding pairs of the subset of the numerical data and the reference values.

7. The machine-implemented method for graphically illustrating a statistical display based on a set of numerical data as claimed in claim 1, wherein the set of numerical data is a natural logarithmic equivalent of a set of source numerical data.

8. A computer program product, comprising a computer readable storage medium that includes program instructions, which when executed by an electronic device, cause the electronic device to perform the machine-implemented method for graphically illustrating a statistical display based on a set of numerical data according to claim 1.

9. An electronic device for graphically illustrating a statistical display based on a set of numerical data, comprising:
a data selecting unit for finding a median of the set of numerical data, and finding a subset of the numerical data, each corresponding to a member of a predetermined set of cumulative distribution probabilities of the Gaussian distribution;
a computing unit for computing a mean of the set of numerical data and a standard deviation of the set of numerical data, and for computing a plurality of reference values, each differing from the mean by a corresponding predetermined number multiplied by the standard deviation of the set of numerical data;
a plot generating unit coupled to said data selecting unit and said computing unit for generating a plot that includes a first line, a second line and a plurality of connecting lines, the first line extending in an axis direction and having the median and the subset of the numerical data found by said data selecting unit marked thereon, the second line extending in the axis direction, being spaced apart from the first line, and having the mean and the reference values computed by said computing unit marked thereon, the connecting lines respectively connecting the median and the mean, and corresponding pairs of the subset of the numerical data and the reference values; and
an output unit coupled to said plot generating unit for outputting the plot for viewing by a user.

10. The electronic device for graphically illustrating a statistical display based on a set of numerical data as claimed in claim 9, wherein:
the predetermined set of cumulative distribution probabilities includes a first cumulative distribution probability that corresponds to a range of within one standard deviation smaller than the mean of the Gaussian distribution, and a second cumulative distribution probability that corresponds to a range of within one standard deviation greater than the mean of the Gaussian distribution;
the subset of the numerical data found by said data selecting unit includes a first one of the numerical data, whose numerical order among the set of the numerical data corresponds to the total number of the numerical data multiplied by the first cumulative distribution probability, and a second one of the numerical data, whose numerical order among the set of the numerical data corresponds to the total number of the numerical data multiplied by the second cumulative distribution probability;
the reference values computed by said computing unit include a first reference value that is smaller than the mean by one standard deviation of the set of numerical data, and a second reference value that is greater than the mean by one standard deviation of the set of numerical data; and
the connecting lines connect the first and second ones of the numerical data respectively to the first and second reference values.

11. The electronic device for graphically illustrating a statistical display based on a set of numerical data as claimed in claim 10, wherein:
the predetermined set of cumulative distribution probabilities further includes a third cumulative distribution probability that corresponds to a range of within two standard deviations smaller than the mean of the Gaussian distribution, and a fourth cumulative distribution probability that corresponds to a range of within two standard deviations greater than the mean of the Gaussian distribution;
the subset of the numerical data found by said data selecting unit further includes a third one of the numerical data, whose numerical order among the set of the numerical data corresponds to the total number of the numerical data multiplied by the third cumulative distribution probability, and a fourth one of the numerical data, whose numerical order among the set of the numerical data corresponds to the total number of the numerical data multiplied by the fourth cumulative distribution probability;
the reference values computed by said computing unit further include a third reference value that is smaller than the mean by two standard deviations of the set of numerical data, and a fourth reference value that is greater than the mean by two standard deviations of the set of numerical data; and
the connecting lines connect the third and fourth ones of the numerical data respectively to the third and fourth reference values.

12. The electronic device for graphically illustrating a statistical display based on a set of numerical data claimed in claim 11, wherein:
the predetermined set of cumulative distribution probabilities further includes a fifth cumulative distribution probability that corresponds to a range of within three standard deviations smaller than the mean of the Gaussian distribution, and a sixth cumulative distribution probability that corresponds to a range of within three standard deviations greater than the mean of the Gaussian distribution;
the subset of the numerical data found by said data selecting unit further includes a fifth one of the numerical data, whose numerical order among the set of the numerical data corresponds to the total number of the numerical data multiplied by the fifth cumulative distribution probability, and a sixth one of the numerical data, whose numerical order among the set of the numerical data corresponds to the total number of the numerical data multiplied by the sixth cumulative distribution probability;
the reference values computed by said computing unit further include a fifth reference value that is smaller than the mean by three standard deviations of the set of numerical data, and a sixth reference value that is greater than the mean by three standard deviations of the set of numerical data; and
the connecting lines connect the fifth and sixth ones of the numerical data respectively to the fifth and sixth reference values.

13. The electronic device for graphically illustrating a statistical display based on a set of numerical data as claimed in claim 9, wherein the plot is presented in a logarithmic scale, said computing unit further taking natural logarithms of a set of source numerical data to generate the set of numerical data.

14. The electronic device for graphically illustrating a statistical display based on a set of numerical data as claimed in claim 13, wherein said computing unit further computes exponentials of the median and the subset of the numerical data found by said data selecting unit, and the mean and the reference values; and
wherein instead of the median and the subset of the numerical data found by said data selecting unit, the first line of the plot generated by said plot generating unit has the exponentials of the median and the subset of the numerical data marked thereon, and instead of the mean and the reference values, the second line of the plot generated by said plot generating unit has the exponentials of the mean and the reference values marked thereon, the connecting lines respectively connecting the exponentials of the median and the mean, and the exponentials of the corresponding pairs of the subset of the numerical data and the reference values.

15. The electronic device for graphically illustrating a statistical display based on a set of numerical data as claimed in claim 9, wherein the set of numerical data is a natural logarithmic equivalent of a set of source numerical data.

16. The electronic device for graphically illustrating a statistical display based on a set of numerical data as claimed in claim 9, wherein said output unit includes a display device for displaying the plot.
